(19) United States
(12) Patent Application Publication
(10) Pub. No.: US 2025/0020822 A1
(43) Pub. Date: Jan. 16, 2025

(54) INVERTING EARTHQUAKE FOCAL MECHANISMS WITH DISTRIBUTED ACOUSTIC SENSING

(71) Applicant: California Institute of Technology, Pasadena, CA (US)

(72) Inventors: Jiaxuan Li, Pasadena, CA (US); Weiqiang Zhu, Berkeley, CA (US); Ettore Biondi, Pasadena, CA (US); Zhongwen Zhan, Arcadia, CA (US)

(73) Assignee: California Institute of Technology, Pasadena, CA (US)

(21) Appl. No.: 18/770,303

(22) Filed: Jul. 11, 2024

Related U.S. Application Data
(60) Provisional application No. 63/526,016, filed on Jul. 11, 2023.

(51) Int. Cl. G01V 1/22; E21B 41/00; G01D 5/353; G01V 1/01; G01V 1/30

(52) U.S. Cl. CPC G01V 1/226; E21B 41/00; G01D 5/35358; G01V 1/01; G01V 1/30; E21B 2200/20

(57) ABSTRACT

The present invention infers the first-motion polarities using the relative polarities measured from cross-correlations. We demonstrate two real-world applications on two DAS arrays in the manuscript to illustrate the effectiveness of our method and improvements to the focal mechanism inversion.

### CROSS-REFERENCE TO RELATED APPLICATIONS

This application claims the benefit under 35 U.S.C. Section 119(e) of co-pending and commonly-assigned U.S. Provisional Patent Application No. 63/526,016, filed Jul. 11, 2023, entitled “Inverting Earthquake Focal Mechanisms With Distributed Acoustic Sensing” by Jiaxuan Li, Weiqiang Zhu, Ettore Biondi, and Zhongwen Zhan, (CIT-9039-P), which application is incorporated by reference herein.

### FIELD OF THE INVENTION

The present invention relates to systems and methods for using Distributed Acoustic Sensing data for focal mechanism inversion or other applications.

### BACKGROUND OF THE INVENTION

Source mechanisms of seismic events are essential for characterizing the faulting process, rupture plane geometry, fluid-solid interaction, and in-situ medium properties ¹⁻⁴. For tectonic crustal earthquakes, analyzing stress state and variation derived from a group of source mechanisms improves our understanding of earthquake-stress interaction ^{5,6} and contributes to the evaluation of seismic hazards ^{7,8}. Source mechanisms of larger earthquakes (magnitude≥3.5) are usually determined by fitting observed waveforms with synthetics ⁹⁻¹¹. For the more frequent smaller earthquakes (magnitude<3.5), their focal mechanisms (i.e. the fault plane solution) generally rely on the first-arrival P-wave polarities ¹²⁻¹⁵, which can be determined through manual picking, bayesian approach, or deep learning ¹⁶⁻¹⁸. Although these focal mechanisms can be further constrained by including P- and S-wave amplitude ratios ^{19,20}, single-event-based focal mechanism determination of small earthquakes tends to have low quality due to the lack of reliable polarity picking. Recently, by taking account of the relative polarities and amplitude ratios between earthquake pairs, a ‘composite’ focal mechanism for a cluster of earthquakes can be constrained with higher accuracy and applied to even smaller earthquakes ²¹⁻²⁵ Such methods require a well-established template database with known polarity picks for historical earthquakes. The focal mechanism accuracy also depends on the coverage of the local seismic network and the spatial distribution of seismicity.

Distributed acoustic sensing (DAS) technology has emerged as a revolutionary seismic monitoring tool, capable of converting fiber-optic cables into dense seismic arrays that extend up to 100 kilometers ²⁶⁻²⁸. By sending laser pulses and measuring the phase change of Raleigh back-scattering from intrinsic fiber-cable impurities, a DAS interrogator unit measures the longitudinal strain or strain rate along either dedicated fiber cable or pre-existing telecommunication fiber cables ^{27,28}. DAS′ wide dynamic range at a broad frequency band has enabled seismic monitoring of earthquakes, volcanic events, and glacial-related seismicities ²⁹⁻³⁵. These studies mainly focus on seismic detection, location, and magnitude estimation utilizing spectral, traveltime, and amplitude information. However, the determination of first-arrival polarities-critical for investigating source mechanisms—has been missing due to DAS′ single-component sensing and weak sensitivity to the direct P-wave arrivals.

Several studies used borehole DAS arrays to characterize source mechanisms of microseismic events by comparing theoretical predictions and synthetic modelings with observed waveforms ³⁶⁻³⁹. Additionally, a case study in Antarctica performed waveform-based inversion of the icequake source mechanism using a one-kilometer-long fiber buried in the snow ⁴⁰. While these studies in special settings demonstrate the potential of using DAS for studying source mechanisms, challenges remain in leveraging the surface fiber cables (such as the extensive pre-existing telecommunication fiber cables) for such purposes. DAS recordings along these fiber cables usually experience higher ambient noise levels, stronger surface scatterings, complex cable geometries, and unknown coupling conditions compared to microseismic monitoring using dedicated fibers cemented in the borehole or snow. Waveform-based source mechanism inversion may be hindered by inaccurate Green's functions due to unaccounted structural or coupling complexities ⁴¹. Additionally, previous polarity determination methods such as deep learning or relative measurement face challenges due to the lack of training labels or well-established template databases on DAS recordings ^{17,18,21}.What is needed, then, are more efficient methods of determining first motion polarities. The present invention satisfies this need.

### SUMMARY OF THE INVENTION

The present disclosure describes a novel data-driven method that uses distributed acoustic sensing (DAS) data to improve the inversion of earthquake focal mechanisms. Specifically, the method can infer the first-motion polarity across each DAS recording channel through cross-correlating P-wave windows between earthquake pairs. By generating a long-range and densely sampled first-motion polarity dataset, the present invention improved the accuracy and decrease the uncertainty of inverted earthquake focal mechanisms.

Our method differs from standard relative measurements, which rely on known polarities from template events to determine unknown polarities of new events. Instead, our relative measurements are all among events with unknown polarities. We take advantage of DAS′ dense spatial sampling and waveform similarities between adjacent channels to obtain the polarities that are consistent across all recording channels.

This method was applied to two DAS arrays and validated the inverted polarities across ˜5,000 channels by comparing them with the predicted polarities derived from the catalog focal mechanism. It was found that inverted polarities correspond directly to the first arrival vertical displacement polarity rather than the longitudinal strain polarity. The inferred polarity reversals along the DAS array contribute to the accurate determination of focal plane orientation. By conducting a joint focal mechanism inversion using both conventional and DAS P-wave polarity picks, we were able to systematically improve the focal mechanism quality for every single earthquake.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

Fig. 1a. Flowchart illustrating a generalized method of the present invention.

FIG. 1b and FIG. 1c. Schematics of a geological structure showing propagation direction of a P-wave and resulting direction of the geological structure (top surface not necessarily the surface of the ground) shaking in response to the P-wave (FIG. 1b taken from USGS website https://www.usgs.gov/media/images/p-waves#:˜:text=Detailed%20Description.direction%20the%20wave%wave%20is%20moving incorporated by reference herein). For natural earthquakes in our study, the incident P wave is almost perpendicular to the ground surface, as illustrated in FIG. 1c, since the velocity of shallow structure is very low (the Snell's Law: lower velocity gives smaller incidence angle (w.r.t the vertical)).

FIG. 2. Workflow of leveraging DAS for earthquake focal mechanism inversion. The workflow consists of three steps. In the preprocessing step, we first use a machine-learning (ML) algorithm to pick the P-phase arrival. We apply a median filter and a bandpass filter between 1 to 10 Hz and extract a twosecond window along the picked P-phase arrival. In the next step, we perform cross-correlations between all earthquake pairs in a cluster, both at the same channel and at adjacent channels. We use the MCCC to pick the relative polarities and derive the channel-consistent polarity. Finally, we input both DAS and conventional polarity picks to search for a jointly inverted focal mechanism.

FIGS. 3a-3f: Retrieval of relative polarity information through cross-correlations between P-wave windows of earthquake pairs. a. Example microstrain rate recording of a local M2.5earthquake bandpass filtered between 1 to 10 Hz. The DAS recording shows clear P and S wave onset marked by the black and green dashed lines. b. P-wave window extracted along the black-dashed line. The strong scattering and low signal-to-noise ratio make polarity picking on raw DAS waveforms challenging. c. P-wave window extracted from another M3.4 earthquake. d. Channel-by-channel cross-correlation between P-wave windows in b and c, with a 10-channel moving average applied along the channel axis to enhance the signal-to-noise ratio. Clear positive cross-correlation peaks (red color) indicate similar P-wave polarities between two earthquakes across all channels. e. Channel-by-channel cross-correlation between b and the P-wave window of another M2.8 earthquake. There are clear polarity flips at channels around 1,000 and 2,000. The negative cross-correlation peaks (blue color) in the middle indicate that these two earthquakes share different P-wave polarities on those channels. f. Similar to e, but the cross-correlation between c and the same M2.8 earthquake.

FIGS. 4a-4h. Inverted DAS polarities as P-wave vertical displacement polarities verified on two DAS arrays. We verify our method using two DAS arrays, one near the Long Valley Caldera, CA (a,c,e,g), and the other near Ridgecrest, CA (b,d,f,h). Each DAS array has about 5,000 channels and a 10-meter channel spacing. a. 25 testing earthquakes (light blue dots) to the south of the DAS array (red line) near the Long Valley Caldera (black closed circle) hosting many faults (solid purple lines) ⁴⁶. The background gray color indicates the topography ⁴⁷. b. Similar to a, 30 testing earthquakes to the northeast of the Ridgecrest DAS array. c-d. Inverted polarities of testing earthquakes on two DAS arrays using relative polarity measurements. e-f. Predicted vertical displacement polarities on two DAS arrays using catalog focal mechanisms. g-h. Predicted longitudinal strain polarities on two DAS arrays using catalog focal mechanisms. The inverted DAS polarities (c,d) are consistent with the predicted vertical displacement polarities (g, h) instead of longitudinal strain polarities (e, f) from catalog focal mechanisms.

FIGS. 5a-5f. Inverting DAS polarities for more earthquakes near the Long Valley Caldera and improving focal mechanism quality through joint inversion a. Similar to FIG. 2a, here shows the map view of a larger region near the Long Valley Caldera with earthquake locations (147 earthquakes marked as light blue dots), fiber cable geometry (red line), and local seismic network (green triangles) indicated. The zoom-in map shows a cluster of 25 earthquakes exhibiting a clear northeast-southwest linear trend near Mt. Morgan, suggesting that these earthquakes may be located on the same fault and share similar focal mechanisms. The black lines represent strike orientations of jointly inverted focal mechanisms. b. Inverted DAS polarities along the fiber cable for all 147 earthquakes. The inverted polarities for the Mt. Morgan cluster are indicated by the horizontal white bar. c. Predicted P-wave vertical displacement polarities using catalog focal mechanisms. White columns represent earthquakes without a focal mechanism solution in the NCEDC catalog ⁴⁴. d. Comparison of obtained focal mechanism quality between inversion using only conventional polarity picks (seis) and joint inversion (joint) using both conventional and DAS polarity picks. e. Focal mechanism nodal lines (gray lines) and TBP axes of jointly inverted focal mechanisms. Here, T represents the tension axis, P represents the pressure axis, and B is defined as the right- hand vector product between T-axis and P-axis. f. Focal mechanism nodal lines and TBP axes of catalog focal mechanisms.

FIGS. 6a-6e. Improving the accuracy and reducing the uncertainty in the focal plane orientation with DAS polarities. a-b. Average focal mechanism solution (red line, with gray background color representing positive first motion) and all accepted solutions (gray lines) for an M1.7 earthquake (event ID: NC73566395). The focal mechanism solution in a uses only conventional polarity picks (crosses and circles with their respective station names indicated). The focal mechanism solution in b uses both conventional and DAS polarity picks (continuous red and blue dots). The polarity changes from red to blue along the fiber cable require the nodal lines to intersect the polarity-flip points. c-d Focal mechanism solutions for another M2.8 earthquake (event ID: NC73482516). The focal mechanism solution using only conventional picks in c indicates a reverse-faulting mechanism, while the jointly inverted focal mechanism in d reveals a strike-slip mechanism. e The focal mechanism solution can also be uniquely determined using only DAS polarities if the fiber cable samples across the nodal lines multiple times.

FIG. 7. Example hardware environment.

FIG. 8. Example network environment.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

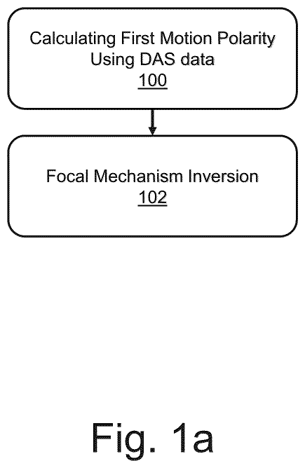

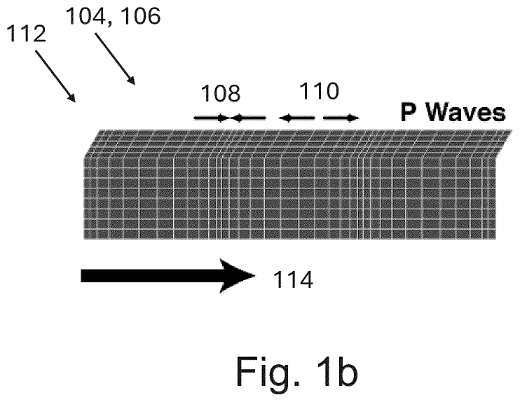

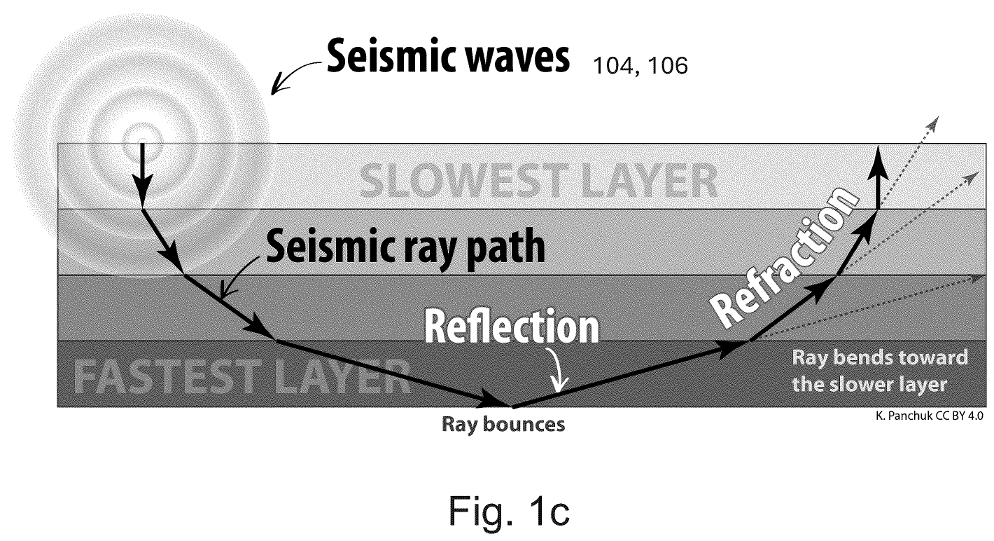

Figure 1a (Fig. 1a) illustrates a computer implemented method comprising the following steps.

Block 100 represents inferring, calculating, or determining, in a computer, polarity of a body wave (e.g., first-motion polarity of P-waves) from analysis of DAS data sensed across each of a plurality of distributed acoustic sensing (DAS) channels (segments of an optical fiber). In one example, the analysis comprises cross-correlating pairs of DAS data sets representing the body waves (e.g., P-waves) received from one or more pairs of seismic events.

Example geological structures include, but are not limited to, the crust or a subsurface of the ground of the Earth, a planet, or other astrophysical object.

Example seismic events or sources include, but are not limited to, an earthquake, volcanic activity, an explosion from an active survey explosive source, a vibration of the ground caused by a hammer, or a vibration of the ground caused by a vehicle.

Each channel is a computationally defined segment (i.e. a virtual segment) of the optical fiber. The (e.g., gauge) length of the channel can have a values selected depending on the size of the region or portion of interest of the seismic wave. In typical examples recording natural earthquakes in fault zones, the channel has a length L of 20 m≤L≤100 m. More generally, the channel is one wavelength of the seismic wave or less, e.g., a portion of the wavelength of interest, e.g., a quarter or a half wavelength).

In typical examples, adjacent channels are spatially spaced by a distance of one wavelength or less, or less than the length of the portion of interest of the seismic wave, so that the portions of the wavelength sensed in each channel are similar. In addition, the spacing between the channels should not be so large that the cross-correlation between adjacent channels is too small (i.e., the spacing between the channels should be sufficiently small that cross correlation between the adjacent channels is above the noise level).

The time window of each of the data sets (i.e., length of time for which the data is obtained in each data set) that are cross-correlated should be long enough to capture one or more wavelengths of the seismic wave of interest, but not so long as to sense other waves which are not of interest (later waves, or S-waves in the case where P-waves are being sensed). Thus, the time window should be tailored to contain only one seismic phase, e.g., the P-wave phase).

Block 102 represents performing a focal mechanism inversion using the first motion polarity obtained using the DAS data sets.

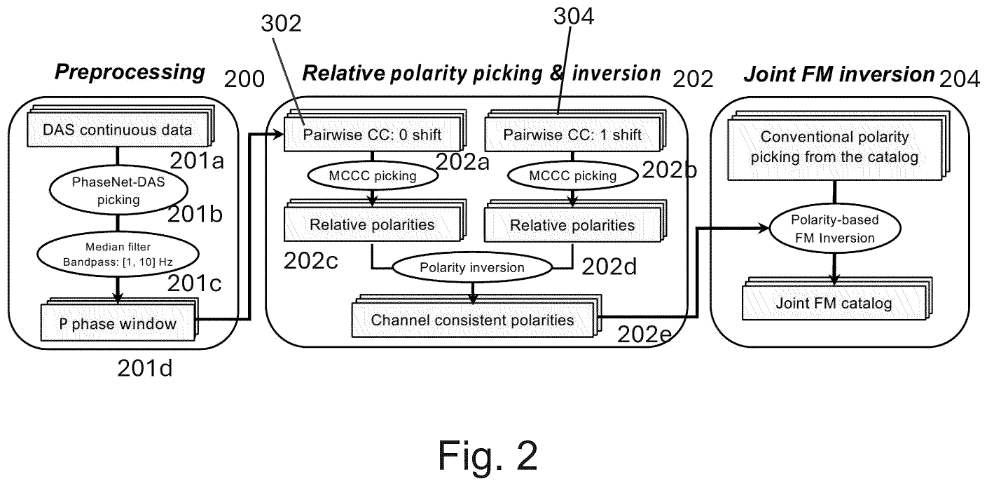

FIG. 2 illustrates an embodiment for determining the polarity of the body wave (e.g., first motion polarities). Block 200 represents pre-processing. The preprocessing comprises applying a filter to set a time window of the DAS data sets to less than 2 seconds or the time window that enables identification of the P-waves from non-P-waves. For the data presented herein, the step comprises using PhaseNet-DAS to extract a 2-second P-phase window from the continuous DAS data ⁴², the waveform is band-pass filtered at a frequency band of 1 to 10 Hz, and a median filter is applied to eliminate the common mode noise ³¹.

Block 202 represents polarity picking and inversion. The step comprises performing pairwise cross-correlations among all similar P-phase windows at each channel (Block 202a) and its adjacent channel (Block 202b). Block 202c represents using MCCC to pick the maximum absolute cross-correlation values, where the sign of the picked value indicates the relative polarity. Block 202d represents inverting the picked relative polarities to obtain the “channel-consistent” polarities for all seismic events and all channels. The final absolute polarity can be obtained (Block 202e) by measuring one or more P-wave polarities on the vertical components of nearby broadband stations.

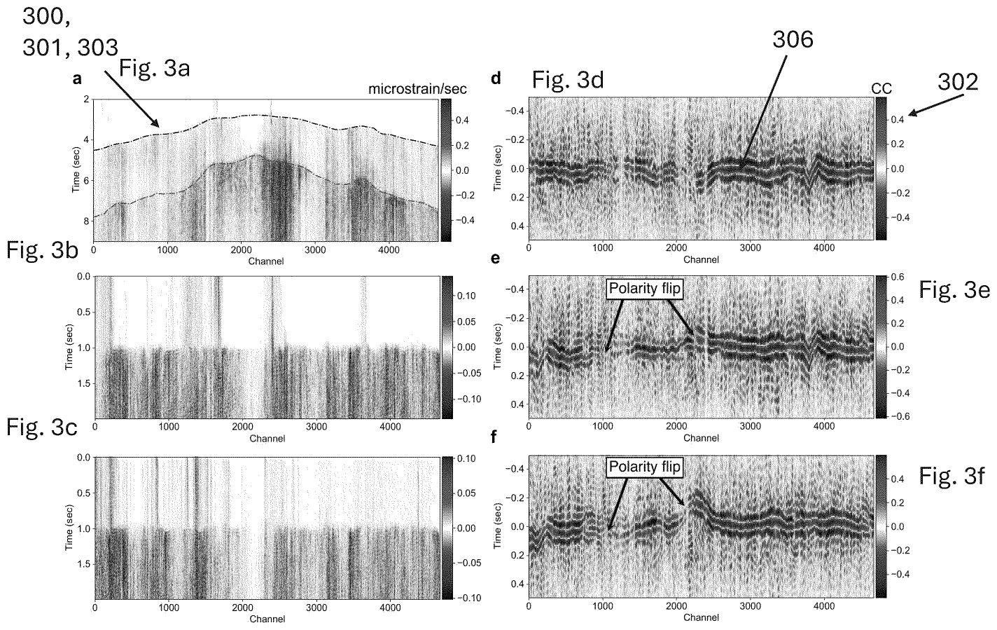

The clear correlation peaks and sharp relative-polarity reversals (with a resolution of tens of meters) across channels (as illustrated in FIG. 3) evidence the presence of robust high-spatial-resolution relative polarity information. In a relative polarity measurement, treating each channel independently allows inference of the unknown polarities from known ones of template events through the singular value decomposition (SVD) of the relative polarity matrix ²¹. However, since all our measurements are among earthquakes with unknown P-wave polarities, there exists a sign ambiguity at each channel. Thanks to the ultra-dense spatial sampling of the DAS array, the waveforms in the P-wave window are similar on neighboring channels. By incorporating the cross-correlations between adjacent channels for all earthquake pairs, the sign ambiguity between channels can be resolved, resulting in corrected polarities that are consistent across all channels. This is referred to as “channel-consistent” polarity. Since all aforementioned measurements are performed in a relative sense, the obtained polarity still contains one sign ambiguity with respect to the absolute polarity of all earthquakes and all channels. This ambiguity can in principle be corrected by determining one polarity pick on a conventional sensor close to the DAS array. In practice, the ambiguity correction is more robust using polarities of multiple events on one or more nearby conventional sensors.

Block 204 represents joint focal mechanism inversion. The first-arrival polarity-based joint focal mechanism inversion is applied using both conventional polarity picks and inverted DAS polarity picks. For the data presented herein, the conventional polarity picks are downloaded from the NCEDC⁴⁴.

### Relative Polarity Picking Using MCCC (Block 202c)

Picking the maximum absolute cross-correlation values on the P-wave correlograms can be used to derive two important pieces of information: (1) the relative polarity, which can be represented by the sign of maximum absolute cross-correlation; and (2) the differential delayed time at each channel, which quantitatively measures the deep-learning picking error. Since the DAS array samples the wavefields densely and continuously in space, the correlograms at nearby channels look similar and are varying smoothly along the channel axis. By performing cross-correlations between neighboring correlograms (e.g., maximum interval of 10 channels in our case for the data presented herein), and measuring the double-differential delay times of the two-fold correlation peaks, we form an overdetermined linear system (equation 1) and solve the double-differential delayed times using least-squares. This approach is known as the multi-channel cross-correlation as described by VanDecar and Crosson ⁴³.

Dτ=Δτ (1)

where D is the differential operator, τ is the absolute differential delayed time of the correlation peak on the correlogram, and Δτ is the measured double-differential delayed time.

The solution to equation 1 is not unique and can be added with any constants. To determine the unique delayed time and pick the signed cross-correlation peaks (relative polarities), we pick the delayed time using the global maximum absolute of the correlograms on each channel and incorporate them in the linear system (equation 2). We then iteratively update the pick in a shrinking picking window centered around the pick until the picking window is less than 0.05 seconds.

$$[ \begin{matrix}λ D \\ I\end{matrix} ] τ = [ \begin{matrix}λ Δτ \\ {τ}_{p}\end{matrix} ] \qquad ( 2 )$$

where I is an identity matrix, τₚ is the picked delayed time, and A is the weight for double-differential smoothing, which is set to 1 in this study.

### Inverting Channel-Consistent DAS Polarities From Relative Measurements (Block 202d)

Consider a cluster of N similar earthquakes observed at K stations. For each event i, there is an unknown polarity Pᵢₖ recorded at station k, where i=1, . . . , N, and k=1, . . . , K. The unknown polarity vector \tilde{P}ₖ=[P₁ₖ, P₂ₖ, . . . , P_{Nk}]^{T} represent polarities recorded at station k for all the N events. Directly determining the polarity is challenging due to the low signal-to-noise ratio and unknown site factors for small earthquakes. However, since these site factors at the same station are similar for different earthquakes, the signs of their cross-correlations or relative polarities are easier to determine. In the case of conventional relative measurements ²¹, we have M template events with known polarities: \tilde{q}ₖ=[Q₁ₖ, Q₂ₖ, . . . , Q_{Mk}]^{T}. We can then form a relative measurement matrix, which is ideally a rank-one matrix formed by the outer product of unknown polarity vector \tilde{P}ₖ and template polarity vector \tilde{q}ₖ at each station k:

$${R}_{NM}^{〈 kk 〉} = {\tilde{p}}_{k} ⊗ {\tilde{q}}_{k} = [ \begin{matrix}{P}_{1 k} {Q}_{1 k} & {P}_{1 k} {Q}_{2 k} & … & {P}_{1 k} {Q}_{Mk} \\ {P}_{2 k} {Q}_{1 k} & {P}_{2 k} {Q}_{2 k} & … & {P}_{2 k} {Q}_{Mk} \\ ⋮ & ⋮ & & ⋮ \\ {P}_{Nk} {Q}_{1 k} & {P}_{Nk} {Q}_{2 k} & … & {P}_{Nk} {Q}_{Mk}\end{matrix} ] \qquad ( 3 )$$

Here, the superscript [symbol] kk [symbol] denotes that the relative measurement is performed at the same station k. The subscript _{NM} denotes that the relative measurement is between N unknown events against M template events. The⊗ denotes the outer product operation between two vectors. We can perform a singular value decomposition (SVD) to the above rank-one matrix:

$${R}_{N M}^{〈 kk 〉} = {U}_{N M}^{〈 kk 〉} {S}_{N M}^{〈 kk 〉} {V}_{N M}^{〈 kk 〉 *} \qquad ( 4 )$$

where the U_{NM}^{<kk>} and V_{NM}^{<kk>} * are orthogonal matrices and S_{NM}^{<kk>} is a diagonal matrix with singular values sorted in descending order. The first column vector of matrix U_{NM}^{<kk>} will then correspond to the unknown polarity vector \tilde{P}ₖ ²¹.

However, for the DAS measurements across thousands of channels, we do not have template events with known polarities. The relative measurement matrix R_{NN}^{<kk>} will be all among events with unknown polarities and is a symmetric matrix formed by the outer product of \tilde{p}ₖ itself:

$${R}_{N N}^{〈 kk 〉} = {\tilde{p}}_{k} ⊗ {\tilde{p}}_{k} = {U}_{N N}^{〈 kk 〉} {S}_{N N}^{〈 kk 〉} {U}_{N N}^{〈 kk 〉 *} \qquad ( 5 )$$

The first column vector ũₖ^{<kk>} of matrix U_{NN}^{<kk>} from the SVD of R_{NN}^{<kk>} will correspond to the unknown polarity vector \tilde{p}ₖ. However, there is a sign ambiguity at each channel k since the SVD still holds if we multiply U_{NN}^{<kk>} with a “−1”. This sign ambiguity at K channels will result in 2^{K} different possible combinations of inverted polarity vectors.

To resolve this ambiguity, we leveraged the high spatial sampling of the DAS array. Since the DAS recording channel spacing (10 meters) is much smaller than the wavelength (>hundreds of meters), the waveforms recorded at nearby channels are similar. The cross-correlations at different channels k and l can still produce high cross-correlation values and robust relative measurements when |k−l| is small. In particular, we calculated pairwise cross-correlations for neighboring channels (k=l−1) and use the MCCC technique to pick the relative polarities and form the relative measurement matrix R_{NN}^{<kl>}:

$${R}_{N N}^{〈 kl 〉} = {\tilde{p}}_{k} ⊗ {\tilde{p}}_{l} = {U}_{N N}^{〈 kl 〉} {S}_{N N}^{〈 kl 〉} {V}_{N N}^{〈 kl 〉 *} \qquad ( 6 )$$

Similarly, the first column vector ũₖ^{<kl>} of U_{NN}^{<kl>} matrix and the first row vector \tilde{v}ₖ^{<kl>} of V_{NN}^{<kl>} from the SVD of R_{NN}^{<kl>} correspond to the unknown polarity vector \tilde{p}ₖ and \tilde{p}ₗ. Although the sign ambiguity still exists, the sign of their multiplication ũₖ^{<kk>}·ũₗ^{<ll>} is unique because the two “-1”'s cancel out in the multiplication. The sign must also be the same as the sign of the multiplication between ũₖ^{<kk>·ũ}ₗ^{<ll>} through the connection of ground-truth relative polarity sign (\tilde{p}ₖ·\tilde{p}ₗ). We then use the following relationship to correct the sign ambiguity of SVD in equation 5:

$$sign ( {\tilde{u}}_{k}^{〈 kk 〉} \cdot {\tilde{u}}_{l}^{〈 ll 〉} ) = sign {( {\tilde{p}}_{k} \cdot {\tilde{p}}_{l} )}_{} = sign ( {\tilde{u}}_{k}^{〈 kl 〉} \cdot {\tilde{v}}_{l}^{〈 kl 〉} ) \qquad ( 7 )$$

For example, if sign (ũₖ^{<kl>}·\tilde{v}ₗ^{<kl>}) is positive, then for \tilde{p}ₖ⊗\tilde{p}ₗ and \tilde{p}ₖ⊗\tilde{p}ₖ the polarity pₖ sensed at channel k is the same as the polarity p₁ sensed at the channel 1 (for k≠1 and also k=1 as in equation 5). On the other hand, if sign(ũₖ^{<kl>·\tilde{v}}ₗ^{<kl>}) is negative, then for \tilde{p}ₖ⊗\tilde{p}ₗ and \tilde{p}ₖ⊗\tilde{p}ₖ the polarity pₖ sensed at channel k is opposite to the polarity p1 sensed at the channel 1 (for k≠1 and also k=1 as in equation 5). Thus the relative polarities detected in response to different seismic events at each channel are known, e.g., wherein the relative polarity comprises a positive value (e.g., +1) if the two body waves involved in the cross-correlation have the same polarity (e.g., both compression or both dilatation/expansion in the case of first motion polarity of P-waves) or a negative value (e.g., −1) if the two body waves in the cross-correlation have different polarity (e.g., one body wave has the first motion polarity that is compression while the other one of the body waves has the first motion polarity that is a dilatation/expansion).

After the correction using cross-correlations on neighboring channels, we can still multiply all the inverted polarities by “−1” simultaneously, and the equations 5 and 6 still hold. This behavior is because all measurements are performed in a relative sense. This last sign ambiguity (i.e., the actual polarity, whether compressive or expansive, for example) can be corrected by picking one P-wave polarity for one of the earthquakes, or more robustly, multiple P-wave polarities from multiple earthquakes recorded at collocated conventional seismometers.

### Example Joint Focal Mechanism Inversion (Block 204)

A grid search for the focal mechanism using both conventional and DAS P-phase polarity picks can be performed. The conventional polarity picks can be downloaded from the NCEDC⁴⁴. The objective function is the ratio of mispredicted polarities averaged between conventional and DAS polarity picks. The acceptable solutions satisfy misfit ratio thresholds independently for conventional and DAS polarity picks. The misfit ratio threshold, defined as the ratio of inconsistent polarity predictions to the total number of polarity picks ¹³, can be set to 15% for conventional polarity picks and 1% for DAS polarity picks through trial and error. However, these parameters can be adjusted as hyperparameters based on the quality of conventional and DAS polarity picks, and the consistency of the joint solution between them. For example, a grid search can be performed on these hyperparameters for specific DAS cables in different regions. The focal mechanism solution can be determined using the average of all accepted solutions. The quality of the solution can be defined in the same way as described in HASH¹³.

### Example Application and Results

### 1. DAS Arrays

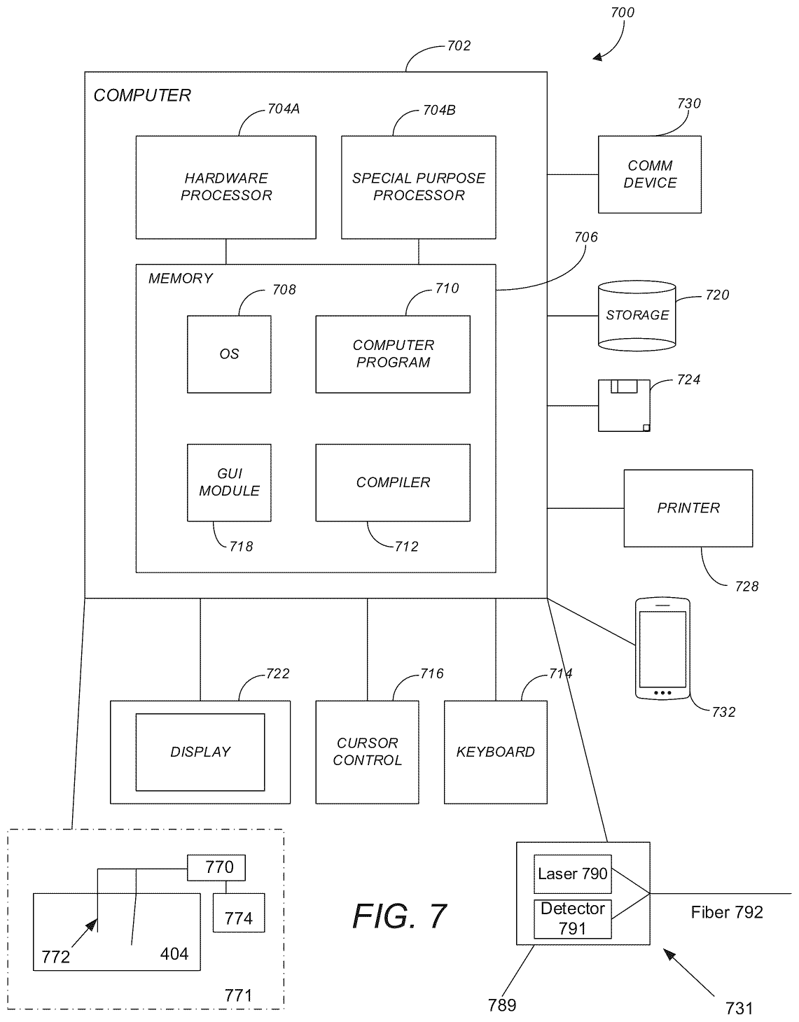

Data was recorded using two DAS arrays in California, one located in Long Valley Caldera, and the other in Ridgecrest. These two DAS arrays have similar interrogation setups, each contains 5,000 channels with a 10-meter channel spacing and a total recording length of approximately 50 kilometers. Both datasets have been resampled to 100 Hz. The data sets presented herein were obtained with an Optasense™ interrogator unit (comprising laser source and detector coupled to an optical fiber), see https://www.optasense.com/diestributed-acoustic-senseing-interrogators (QuantX model), however this is merely an example and other instruments can be used. FIG. 7 illustrates a typical DAS interrogator unit 789 comprises the laser source 790 and detector 791 coupled to an optical fiber 792 which is usually part of (e.g., a dark fiber in) a network telecommunications cable or bundle of optical fibers.

### Inverted Polarities as the P-Wave Vertical Displacement Polarity

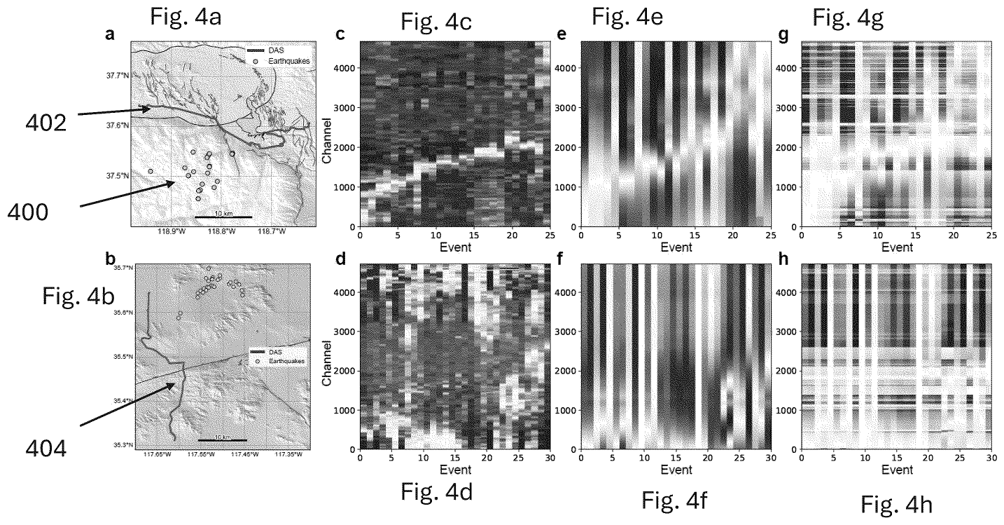

The data analysis of FIG. 2 was applied to the DAS data obtained from the two DAS arrays. For the Long Valley Caldera DAS array, the method was tested on 25 local earthquakes that share similar waveforms and have magnitudes ranging from 1 to 3.4. The P-phase window was extracted using a deep-learning phase picker ⁴². Cross-correlations was performed for all the earthquake pairs, and the correlation peaks were determined using multi-channel cross-correlations (MCCC) [symbol] . With about 3 million relative polarity picks, we inverted the “channel-consistent” polarities for the 25 earthquakes across ˜5,000 channels. Using the focal mechanism catalog from the Northern California Earthquake Data Center (NCEDC) ⁴⁴, the observed polarity on all DAS channels could be predicted. It was found that the inverted polarities match well with the predicted vertical displacement polarities instead of the predicted longitudinal-strain polarities (FIG. 4).

Similarly, for the Ridgecrest DAS array, the same procedure was applied to 30 local earthquakes. The inverted polarities demonstrate good agreement with the predicted vertical displacement polarities using the focal mechanisms from the Southern California Earthquake Data Center (SCEDC) ⁴⁵.

The underlying physical mechanism for these results is that the primary contributions to the cross-correlations between Pwave windows of earthquake pairs come from surface scatterings since a horizontal fiber cable has weaker sensitivity to the near-vertical first motion. Moreover, the sign of the surface scatterings directly corresponds to the direction of initial movement caused by incident P waves. Therefore, even though it is hard to directly determine first-motion polarity from the raw waveforms due to DAS′ low signal-to-noise ratio and horizontal sensitivity, we can robustly infer the relative first-motion polarity between earthquake pairs. More specifically, a positive cross-correlation value between two P-wave windows indicates the same initial movement direction of incident P waves, while a negative value indicates an opposite initial movement direction.

### Improved Focal Mechanisms With DAS Polarity Picks

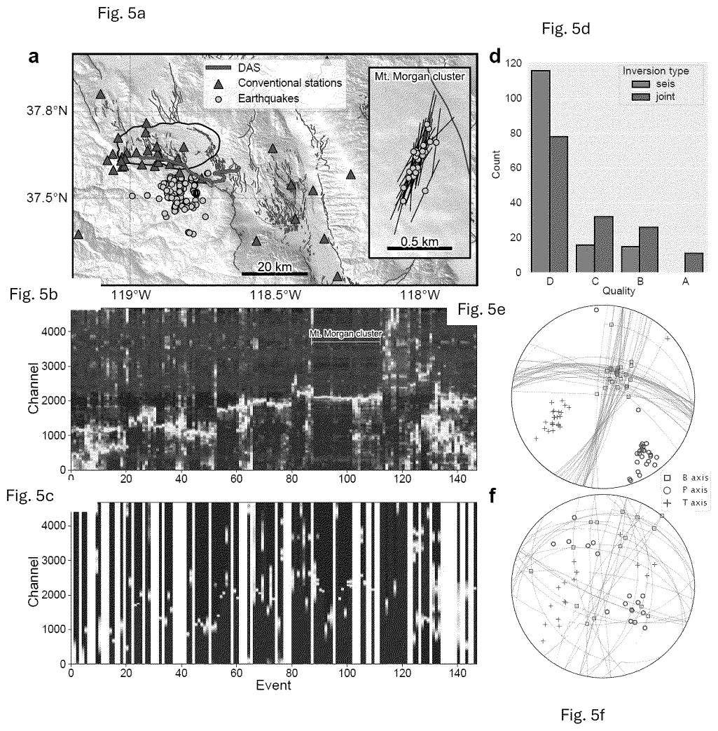

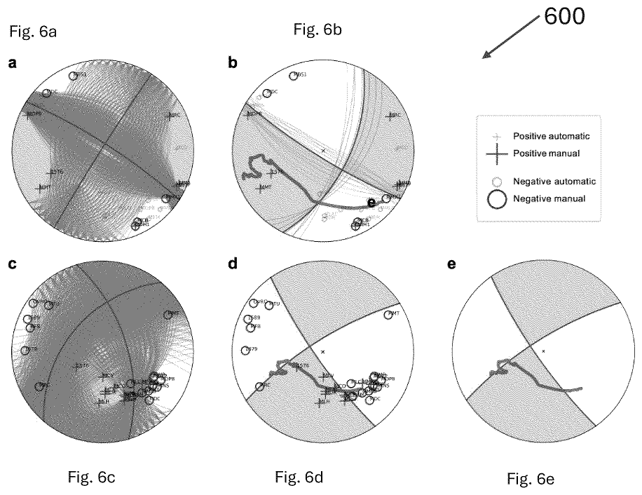

After the verification of the method on two small clusters of earthquakes, the analysis was extended to a larger number of earthquakes using the Long Valley Caldera DAS array. Specifically, relative polarity measurements were performed for 147 local earthquakes with magnitudes ranging from 0.5 to 3.4 (FIG. 5a). Following the same workflow, the polarities were derived for all 147 earthquakes across all recording DAS channels. The inverted polarities were compared with the ones predicted by the focal mechanisms from the NCEDC catalog (FIG. 6b, c). Even though some earthquakes have no focal mechanisms available from the catalog (white vertical columns in FIG. 6c), we can still robustly invert for their polarities along the DAS array. In general, the inverted polarities show good agreement with the predicted ones. However, the polarity-reversal points predicted from the catalog appear to be more scattered compared to our inverted results. This scattering results from the errors in the catalog focal mechanism.

The NCEDC catalog determines the focal mechanism based on first-arrival polarities ¹², and their accuracy is usually limited by the azimuthal coverage. With the inverted DAS polarities, the azimuthal gap can be filled by performing a joint focal mechanism inversion using both conventional and DAS polarity picks. In addition to the improvement of the azimuthal coverage, the inverted polarity flips along the fiber cable can tightly constrain the focal plane orientation. FIG. 6 shows two examples of joint focal mechanism inversion. With the inverted polarity flips, all acceptable focal planes must intersect the transition point and separate the positive and negative segments of polarities, which can improve the accuracy and lower the uncertainty. With multiple inverted polarity flips (FIG. 6d), we can uniquely determine the focal mechanism, with uncertainties nearly contributed solely by the ray paths. Notably, for the example in FIG. 6d, a focal mechanism inversion using only DAS polarity picks can achieve the same resolution (FIG. 6e). This example demonstrates that one DAS array is sufficient to fully constrain the focal mechanism given enough sampling in different quadrants. More strictly speaking, if the DAS can sample at least once across one nodal line and twice across the other nodal line, the focal mechanism (the fault plane) solution can be uniquely determined. Overall, by incorporating the inverted DAS polarities, the focal mechanism quality can be systematically improved for individual earthquakes (FIG. 5). More specifically, the root-mean-square (RMS) angle differences of the accepted solutions from the preferred solution have been decreased by 15° on average.

The inverted DAS polarities and the improvement of joint-inverted focal mechanisms were further validated by examining a cluster of linearly distributed earthquakes. The northeast-southwest linear trend of this earthquake cluster suggests that these earthquakes may be located on the same geological faults and share similar focal plane orientations (inset figure in FIG. 5a). Indeed, the inverted DAS polarities of those earthquakes show considerable similarities, while the predicted polarities using catalog focal mechanisms show greater variations among events (FIG. 5b, c). The joint-inverted focal mechanisms show more concentrated compression (P) & tension (T) axes compared to the catalog focal mechanisms (FIG. 5e, f). Moreover, the inverted strike angles align well with the northeast-southwest linear trend of the earthquake distribution (inset figure in FIG. 5a).

### Possible Modifications, Variations, and Applications.

Additional constraints for studying focal mechanisms with DAS can be derived by performing relative S-wave polarity and P/S amplitude ratio measurements. Furthermore, beyond the fault plane solution, DAS can potentially facilitate the characterization of the non-double-couple components, which is critical to revealing the complex underlying rupture mechanisms. More specifically, DAS polarities can be used to cross-validate the full moment tensor solution derived by conventional stations. However, it is important to note the limitations of our method. There is a high computation cost due to the large number of DAS channels. For example, performing MCCC on thousands of DAS channels would require solving a large sparse matrix through least-squares. Such problems can be addressed through the implementation of a GPU-based MCCC picker or by training a deep-learning-based MCCC picker. A numerical study should be conducted to systematically investigate the response of correlation functions to surface scatterings caused by topography or velocity heterogeneities so that these can be taken into account.

Note that, once polarities are obtained on one DAS array for a cluster of earthquakes, their P-wave windows can act as known templates or labels which can then be used to determine P-wave polarities of new events through either relative measurements or deep learning ^{17,18,21}. For example, by cross-correlating the continuous recordings using the established DAS template database, smaller earthquakes can be detected using the conventional template-matching technique. Meanwhile, if clear correlation peaks exist across channels, the MCCC can be used to pick DAS-based differential traveltime and relative polarity for high-resolution earthquake relocation and source mechanism inversion. By routinely streaming the data, we anticipate DAS to continuously produce robust polarity picks for pursuing a better focal mechanism catalog and a more accurate understanding of tectonic stress distributions and variations.

This focal mechanism inversion technology on DAS has wide ranging applications. It can be used to infer accurate fault orientation and underground stress status in various scenarios.

For example, it can be employed in earthquake/microseismic monitoring of not only natural earthquakes to complement current seismic networks but also monitoring of induced earthquakes in geothermal reservoirs or carbon storage and sequestration (CSS) sites. Additionally, the application can extend to off-shore fiber cables, offering a cost-effective alternative to sparsely deployed, expensive ocean-bottom seismometers.

Theoretically, if the fiber cable samples across one nodal line once and the other nodal line twice on the beach ball, the focal mechanism can be uniquely determined, since the focal mechanism has only three independent parameters. The remaining uncertainties can be attributed to takeoff angles due to inaccurate earthquake locations and unaccounted velocity structures. These results motivate the design of fiber geometries optimized for the monitoring application, e.g., microseismicity in natural earthquakes, geothermal reservoirs, carbon storage and sequestration (CSS) sites, or for offshore fiber cables used for ocean-bottom seismometers.

FIG. 7 illustrates geothermal systems 771 that generate energy and power from heat in the geological structure/field typically comprise drill holes 772 or wells (e.g., injection and production wells) to extract the heat from fluids (e.g. water) pumped and/or extracted from the geological structure. Geological structures may also contain drill holes 772 to access shale gas or other fossil fuel reserves/fields through hydraulic fracking systems 771 (e.g. using fluid such as water). Carbon storage and sequestration sites 771 may also contain drill holes 772 for injecting fluid (e.g., carbon dioxide) into the geological structure for storage. The stress data, fracture network, focal mechanism geometry of fractures and/or other fault zone data (including, but not limited to, at the micro-seismic level) obtained using the polarity of the body waves (as determined herein) can be used to generate improved focal mechanism catalog, and thus simulations of, e.g., the fluid motion, to predict future energy production, identify new potential energy sources, and/or maintain proper operation (and safety) of the energy generating/drilling or storage systems and fields. For example, the simulations can be used to determine the possibility of fluid flow through major faults so that preventative measures can be taken.

### Hardware Environment

FIG. 7 is an exemplary hardware and software environment 700 (referred to as a computer-implemented system and/or computer-implemented method) used to implement one or more embodiments of the invention. The hardware and software environment includes a computer 702 and may include peripherals. Computer 702 may be a user/client computer, server computer, or may be a database computer. The computer 702 comprises a hardware processor 704A and/or a special purpose hardware processor 704B (hereinafter alternatively collectively referred to as processor 704) and a memory 706, such as random access memory (RAM). The computer 702 may be coupled to, and/or integrated with, other devices, including input/output (I/O) devices such as a keyboard 714, a cursor control device 716 (e.g., a mouse, a pointing device, pen and tablet, touch screen, multi-touch device, etc.) and a printer 728. In one or more embodiments, computer 702 may be coupled to, or may comprise, a portable or media viewing/listening device 732 (e.g., an MP3 player, IPOD, NOOK, portable digital video player, cellular device, personal digital assistant, etc.). In yet another embodiment, the computer 702 may comprise a multi-touch device, mobile phone, gaming system, internet enabled television, television set top box, or other internet enabled device executing on various platforms and operating systems.

In one embodiment, the computer 702 operates by the hardware processor 704A performing instructions defined by the computer program 710 (e.g., a first motion polarity picking and focal mechanism inversion application) under control of an operating system 708. The computer program 710 and/or the operating system 708 may be stored in the memory 706 and may interface with the user and/or other devices to accept input and commands and, based on such input and commands and the instructions defined by the computer program 710 and operating system 708, to provide output and results.

Output/results may be presented on the display 722 or provided to another device for presentation or further processing or action. In one embodiment, the display 722 comprises a liquid crystal display (LCD) having a plurality of separately addressable liquid crystals. Alternatively, the display 722 may comprise a light emitting diode (LED) display having clusters of red, green and blue diodes driven together to form full-color pixels. Each liquid crystal or pixel of the display 722 changes to an opaque or translucent state to form a part of the image on the display in response to the data or information generated by the processor 704 from the application of the instructions of the computer program 710 and/or operating system 708 to the input and commands. The image may be provided through a graphical user interface (GUI) module 718. Although the GUI module 718 is depicted as a separate module, the instructions performing the GUI functions can be resident or distributed in the operating system 708, the computer program 710, or implemented with special purpose memory and processors.

In one or more embodiments, the display 722 is integrated with/into the computer 702 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld devices), touch tables, and walls (e.g., where an image is projected through acrylic and/or glass, and the image is then backlit with LEDs).

Some or all of the operations performed by the computer 702 according to the computer program 710 instructions may be implemented in a special purpose processor 704B. In this embodiment, some or all of the computer program 710 instructions may be implemented via firmware instructions stored in a read only memory (ROM), a programmable read only memory (PROM) or flash memory within the special purpose processor 704B or in memory 706. The special purpose processor 704B may also be hardwired through circuit design to perform some or all of the operations to implement the present invention. Further, the special purpose processor 704B may be a hybrid processor, which includes dedicated circuitry for performing a subset of functions, and other circuits for performing more general functions such as responding to computer program 710 instructions. In one embodiment, the special purpose processor 704B is an application specific integrated circuit (ASIC), field programmable gates array (FPGA), or other integrated circuit configured or adapted for performing or executing machine learning (e.g., algorithms) or artificial intelligence, or a graphics processing unit (GPU).

The computer 702 may also implement a compiler 712 that allows an application or computer program 710 written in a programming language such as C, C++, Assembly, SQL, PYTHON, PROLOG, MATLAB, RUBY, RAILS, HASKELL, or other language to be translated into processor 704 readable code. Alternatively, the compiler 712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 710 accesses and manipulates data accepted from I/O devices and stored in the memory 706 of the computer 702 using the relationships and logic that were generated using the compiler 712.

The computer 702 also optionally comprises an external communication device such as a modem, satellite link, Ethernet card, or other device for accepting input from, and providing output to, other computers 702.

In one embodiment, instructions implementing the operating system 708, the computer program 710, and the compiler 712 are tangibly embodied in a non-transitory computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of computer program 710 instructions which, when accessed, read and executed by the computer 702, cause the computer 702 to perform the steps necessary to implement and/or use the present invention or to load the program of instructions into a memory 706, thus creating a special purpose data structure causing the computer 702 to operate as a specially programmed computer executing the method steps described herein. Computer program 710 and/or operating instructions may also be tangibly embodied in memory 706 and/or data communications devices 730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 702.

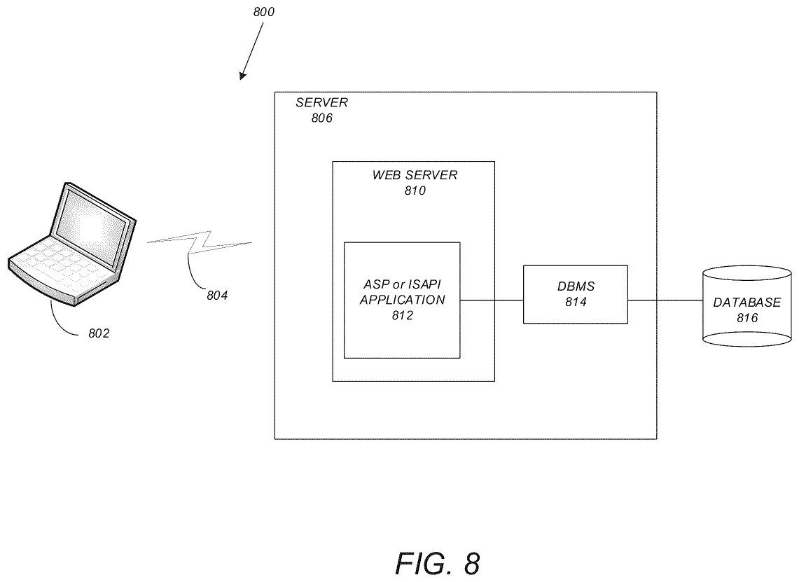

FIG. 8 schematically illustrates a typical distributed/cloud-based computer system 800 using a network 804 to connect client computers 802 to server computers 806. A typical combination of resources may include a network 804 comprising the Internet, LANs (local area networks), WANs (wide area networks), SNA (systems network architecture) networks, or the like, clients 802 that are personal computers or workstations (as set forth in FIG. 7), and servers 806 that are personal computers, workstations, minicomputers, or mainframes (as set forth in FIG. 7). However, it may be noted that different networks such as a cellular network (e.g., GSM [global system for mobile communications] or otherwise), a satellite based network, or any other type of network may be used to connect clients 802 and servers 806 in accordance with embodiments of the invention.

A network 804 such as the Internet connects clients 802 to server computers 806. Network 804 may utilize ethernet, coaxial cable, wireless communications, radio frequency (RF), etc. to connect and provide the communication between clients 802 and servers 806. Further, in a cloud-based computing system, resources (e.g., storage, processors, applications, memory, infrastructure, etc.) in clients 802 and server computers 806 may be shared by clients 802, server computers 806, and users across one or more networks. Resources may be shared by multiple users and can be dynamically reallocated per demand. In this regard, cloud computing may be referred to as a model for enabling access to a shared pool of configurable computing resources.

Clients 802 may execute a client application or web browser and communicate with server computers 806 executing web servers 810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 802 may be downloaded from server computer 806 to client computers 802 and installed as a plug-in or ACTIVEX control of a web browser. Accordingly, clients 802 may utilize ACTIVEX components/component object model (COM) or distributed COM (DCOM) components to provide a user interface on a display of client 802. The web server 810 is typically a program such as MICROSOFT′S INTERNET INFORMATION SERVER.

Web server 810 may host an Active Server Page (ASP) or Internet Server Application Programming Interface (ISAPI) application 812, which may be executing scripts. The scripts invoke objects that execute business logic (referred to as business objects). The business objects then manipulate data in database 816 through a database management system (DBMS) 814. Alternatively, database 816 may be part of, or connected directly to, client 802 instead of communicating/obtaining the information from database 816 across network 804. When a developer encapsulates the business functionality into objects, the system may be referred to as a component object model (COM) system. Accordingly, the scripts executing on web server 810 (and/or application 812) invoke COM objects that implement the business logic. Further, server 806 may utilize MICROSOFT'S TRANSACTION SERVER (MTS) to access required data stored in database 816 via an interface such as ADO (Active Data Objects), OLE DB (Object Linking and Embedding DataBase), or ODBC (Open DataBase Connectivity).

Generally, these components 800-816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 802 and 806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 802 and 806. Embodiments of the invention are implemented as a software application on a client 802 or server computer 806. Further, as described above, the client 802 or server computer 806 may comprise a thin client device or a portable device that has a multi-touch-based display.

### EXAMPLE EMBODIMENTS

### Embodiments of the Present Invention Include, but are not Limited to, the Following (Referring Also to 1-8)

1. A computer-implemented method, comprising:
obtaining (e.g., inferring, calculating, deriving, or determining 100), using a computer 702, a polarity 108, 110 of body waves sensed across each of a plurality of distributed acoustic sensing (DAS) channels by cross-correlating pairs of DAS data sets 300 representing the body waves 104 (e.g., P-waves 106, 3 dimensional waves in the ground) received from one or more pairs of seismic events 400; and
performing, using the computer, a focal mechanism inversion 600 using the polarity obtained using the DAS data sets (e.g., but not limited to, minimizing the predicted polarity with picked ones to find a solution (e.g., faulting motions and fault orientation) [50]). In one or more embodiments, performing the focal mechanism inversion comprises determining the faulting motions (e.g., direction of slip) and orientation of the fault that produces the seismic event (e.g., earthquake).
2. The method of clause 1, wherein the body waves 104 are P-waves and the polarity is a first-motion polarity (e.g., compressive 108 or dilatative 110) of the P-waves.
3. The method of clause 1 or 2, further comprising:
the cross-correlating 202a, 202b between all the pairs of the DAS data sets, both at the same one of the channels and adjacent ones of the channels, to obtain same channel correlation data 302 and adjacent channel correlation data 304;
picking 202c relative polarities of the correlation data;
deriving channel consistent polarities 202e of the correlation data; and
performing the focal mechanism inversion 204 using the channel consistent polarities and non-DAS polarity picks as inputs, to obtain a focal mechanism.
4. The method of any of the clauses 1-3, further comprising:
obtaining 201a the distributed acoustic sensing (DAS) data sets, comprising changes in strain in an optical fiber 402 as a function of time, wherein each of the sets are generated in response to a different one of a plurality of seismic events and the optical fiber is embedded in a geological structure 404, 112;
performing 202a the cross-correlating of one or more pairs of the sets associated with the P-waves sensed in a same one of the channels of the optical fiber, to obtain same channel correlation data 302;
performing the cross-correlating 202b of the one or more pairs of the sets associated with the P-waves sensed at two different adjacent ones of the channels, to obtain adjacent channel correlation data 304;
using 202d the adjacent channel correlation data to correct a sign ambiguity in the same channel correlation data, to obtain corrected correlation data;
using 202d the corrected correlation data to determine relative signs of the first motion polarities of the P-waves from all the seismic events; and
determining 202e the first motion polarities (e.g., compressive 108 or dilatative 110) of the P-waves 106 from all the seismic events 400, from a knowledge (e.g., whether compressive or dilatative) of at least one of the first motion polarities and the relative signs.
5. The method of any of the clauses 1-4, wherein the seismic events 400 are earthquakes having a magnitude of 3.5 or less or 4 or less on the Richter scale.
6. The method of any of the clauses 1-5, wherein the relative sign comprises a positive value (e.g., +1) if the two body waves involved in the cross-correlation have the same polarity (e.g., both compression or both dilatation/expansion in the case of first motion polarity of P-waves) or a negative value (e.g., −1) if the two body waves in the cross-correlation have different polarity (e.g., one body wave has the first motion polarity that is compression while the other one of the body waves has the first motion polarity that is a dilatation/expansion).
7. The method of any of the clauses 1-6, wherein the length of the each of the channels is less than the wavelength of the body wave of interest.
8. The method of any of the clauses 1-7, wherein a spacing (spatial separation) between the two adjacent ones of the channels is less than the wavelength, or a portion of the wavelength of the body wave of interest.
9. The method of any of the clauses 4-8, wherein the knowledge is obtained

from a measurement of the polarity using a an inertial sensor or other conventional sensor.
10. The method of any of the clauses 1-9, wherein the arrivals of the P-waves and/or the correlations between the DAS data sets, comprising positive and negative correlations, are picked 201b using a machine learning algorithm.
11. The method of any of the clauses 1-10, wherein the correlations between the DAS data sets are picked using multi-channel cross-correlations.
13. The method of any of the clauses 1-11, wherein the cross-correlation xcor is between the DAS data sets comprising two time series a(t) and b(t):

$$x cor ( τ ) = \frac{{\sum }_{i = 0}^{N} a ( t ) b ( t + τ )}{\sqrt{{\sum }_{i = 0}^{N} {a ( t )}^{2}} \sqrt{{\sum }_{i = 0}^{N} {b ( t )}^{2}}}$$

14. The method of any of the clauses 1-13, wherein the DAS data sets each comprise waveforms 301 (strain of the ground as a function of time, which is spatial gradient of displacement along the fiber 792, 402) associated with travel times from one or more seismic source (for the two different seismic events in the event pair) to the channel or the adjacent channels, so that the cross-correlation is between the body waves having different travel times.
15. The method of clause 14, further comprising the optical fiber 402, 792 and an interrogator 789 coupled to the optical fiber, wherein the interrogator comprises a laser source 790 for outputting laser pulses into the fiber 792 a detector 791 for detecting backscattering of the laser pulses from the optical fiber in response to deformations of the geological structure 112, 404 in contact with the optical fiber and caused by the seismic events 400.
16. The system of any of the clauses 1-15, wherein one or more of the processors 704a, 704b define the channels comprising a length corresponding to at least one of a time range, frequency range, or phase range of the backscattering of the laser pulses detected by the detector.
17. The method of any of the clauses 3-16, further comprising:
using single value decomposition to invert a matrix equation representing the cross correlation data (without the sign ambiguity) to obtain the relative signs;
assigning the polarity (e.g., first motion polarities) from the relative signs using the knowledge of at least one of the polarities.
18. The method of any of the clauses 1-17, further comprising applying a filter 201c to set a time window 201d of the DAS data sets to less than 2 seconds or the time window 303 long enough to capture one or more periods of the dominant frequencies (e.g., frequencies or wavelengths of the body wave of interest) but short enough to not to include later slower waves (or other seismic phases) that are not of interest.
19. The method of any of the clauses 1-18, further comprising inferring, determining, and/or calculating, from the inversion, at least one of a fault orientation or a stress status associated with seismic events.
20. The method of any of the clauses 1-19, further comprising monitoring earthquakes using the focal mechanism inversion.

21. The method of any of the clauses 1-20, wherein the seismic event 400 (e.g., earthquake) is generated in one or more fault zones onshore or offshore, a geothermic reservoir 7711, or carbon storage and sequestration location 771.

22. A computer-implemented system 700, comprising:
(a) one or more computers 702 having one or more memories;
(b) one or more processors 704A, 704B executing on the one or more computers;
(c) the one or more memories 708 storing one or more sets of instructions, wherein the one or more sets of instructions, when executed by the one or more processors cause the one or more processors to perform operations comprising:
calculating a polarity 108, 110 of body waves 104, 106 sensed across each of a plurality of distributed acoustic sensing (DAS) channels by cross-correlating pairs of DAS data sets 300 representing the body waves received from one or more pairs of seismic events; and
performing a focal mechanism inversion 600 using the polarity obtained using the DAS data sets 300.
23. The system of clause 22, wherein the channels are computationally defined in an optical fiber 402, 792 embedded in a geological structure 404 coupled to the seismic events, the system further comprising an interrogator 789 coupled to the optical fiber, wherein the interrogator comprises a laser source 790 for outputting laser pulses into the fiber, and a detector 791 for detecting backscattering of the laser pulses from the optical fiber in response to deformations of the geological structure in contact with the optical fiber and caused by the seismic events 400.
24. The system of clause 23 or 22, wherein one or more of the processors 704A, 704B define the channels each comprising a length corresponding to at least one of a time range, frequency range, or phase range of the backscattering of the laser pulses detected by the detector.
25. The system of any of the clauses 22-24, further comprising a system 771 comprising holes or wells 772 drilled in the geological structure for extracting energy from the geological structure using a fluid pumped into and/or extracted from the geological structure 404 through the holes or wells and using pumping/extraction system 770, and one or more of the computers 702 comprising one or more processors using the focal mechanism inversion as an input for simulating fluid flow in the holes or wells so as to monitor and/or predict energy production from the system of the holes or wells.
26. The system of clause 25, further comprising a controller 774 (e.g., computer system 700) for controlling the energy production or fluid flow in the holes or wells based on the simulation.
27. The system of any of the clauses 22-26, wherein the system implements (or the one or more processors perform) the operations in any of the clauses 1-21.
28. A computer-readable storage medium storing instructions that, when executed by a computing system, cause the computing system to perform a process comprising.
inferring a polarity of body waves sensed across each of a plurality of distributed acoustic sensing (DAS) channels by cross-correlating pairs of DAS data sets representing the body waves received from one or more pairs of seismic events; and
performing a focal mechanism inversion using the polarity obtained using the DAS data sets.
29. The medium of clause 28 implementing or using the system or method of any of the clauses 1-27.
30. The medium, system, or method of any of the clauses 1-29 integrated in the practical application of extracting energy from a geothermal reservoir, fossil fuel reserve, storing carbon, monitoring earthquakes or any other practical application described herein.

### Advantages and Improvements

This invention presents several advantages and improvements as compared to the limitations of conventional datasets and methods.
1. The rapidly developing DAS technology is converting extensive onshore or offshore fiber cables into sensitive seismic antennas. For the fast-growing DAS dataset, previous studies with DAS mainly explore seismic detections and locations. While the source mechanism is an essential seismic attribute, there have been only a few attempts using DAS through comparing or fitting synthetic waveforms with observed ones (see [32], [36-40] for use waveforms for source mechanisms, and [35], [41], [48] for site coupling and surface scattering). These methods, however, suffer from inaccurate Green's functions for recordings on surface fiber cables due to unknown site couplings and strong surface scatterings (i.e., these methods mainly focus on waveform-based focal mechanism inversion with DAS, which can be hindered by inaccurate Green's functions caused by unaccounted structural or coupling complexities). In contrast, the method described herein provides a data-driven approach that can densely sample polarity variations over tens of kilometers. By integrating DAS polarities into the current seismic network, the focal mechanism inversion quality can be systematically improved.
2. Although DAS arrays can record clear P-wave and S-wave onset of local small earthquakes (FIG. 3a), picking the P-wave polarity directly from the strain-rate waveform is challenging for two reasons: First, the DAS recording has lower signal-to-noise ratios compared to conventional broadband stations. Second, DAS recording is more sensitive to locally scattered surface waves than vertical particle motions induced by incident direct P waves because the DAS unit is interrogating along a horizontal fiber. Nevertheless, the channel-by-channel cross-correlations between the P-wave windows of earthquake pairs can exhibit clear correlation peaks (FIG. 3d-f) as the patterns of local scatterers are similar for different earthquakes. A positive correlation coefficient indicates that those two earthquakes share the same polarity, while a negative correlation value implies an opposite polarity on a given channel. The clear correlation peaks and sharp relative-polarity reversals (with a resolution of tens of meters) across channels show that these cross-correlations contain robust high-spatial-resolution relative polarity information.
3. Focal mechanisms of the frequent and smaller (magnitude<3.5) earthquakes traditionally rely on the first-arrival P-wave polarities recorded by the inertial sensors. Their qualities tend to be low due to the limited azimuthal coverage of the local seismic network and the lack of reliable polarity picking. However, by leveraging DAS, which can continuously measure the strain or strain rate data over extensive distances (tens of kilometers) with a high spatial resolution (tens of meters), this approach can fill the azimuthal gap through the long sensing range and better constrain the focal plane orientation through the inferred polarity reversals along the fiber cable.

### DATA AVAILABILITY

The catalog focal mechanisms and conventional polarity picks are available from the NCEDC and SCEDC data centers. The DAS P-phase dataset used in this study is available at https://doi.org/10.22002/n47vys0s65.

### References

The following references are incorporated by reference herein.
[1] Cliff Frohlich. Earthquakes with Non-Double-Couple Mechanisms. Science, 264(5160):804-809, May 1994. doi: 10.1126/science.264.5160.804. URL https://www.science.org/doi/10.1126/science.264.5160.804. Publisher: American Association for the Advancement of Science.
[2] Bruce R. Julian, Angus D. Miller, and G. R. Foulger. Non-double-couple earthquakes 1. Theory. Reviews of Geophysics, 36(4):525-549, 1998. ISSN 1944-9208. doi: 10.1029/98RG00716. URL https://onlinelibrary.wiley.com/doi/abs/10.1029/98RG00716._eprint: https://onlinelibrary.wiley.com/doi/pdf/10.1029/98RG00716.
[3] Douglas S. Dreger, Hrvoje Tkalčić, and Malcolm Johnston. Dilational Processes Accompanying Earthquakes in the Long Valley Caldera. Science, 288(5463):122-125, April 2000. doi: 10.1126/science.288.5463.122. URL https://www.science.org/doi/full/10.1126/science.288.5463.122. Publisher: American Association for the Advancement of Science.
[4] Jiaxuan Li, Yingcai Zheng, Leon Thomsen, Thomas J. Lapen, and Xinding Fang. Deep earthquakes in subducting slabs hosted in highly anisotropic rock fabric. Nature Geoscience, 11(9):696-700, September 2018. ISSN 1752-0908. doi: 10.1038/s41561-018-0188-3. URL https://www.nature.com/articles/s41561-018-0188-3. Number: 9 Publisher: Nature Publishing Group.
[5] Andrew J. Michael. Determination of stress from slip data: Faults and folds. Journal of Geophysical Research: Solid Earth, 89(B13):11517-11526, 1984. ISSN 2156-2202. doi: 10.1029/JB089iB13p11517. URL https://onlinelibrary.wiley.com/doi/abs/10.1029/JB089iB13p11S17._eprint: https://onlinelibrary.wiley.com/doi/pdf/10.1029/JB089iB13p11517.
[6] Jeanne L. Hardebeck and Tomomi Okada. Temporal Stress Changes Caused by Earthquakes: A Review. Journal of Geophysical Research: Solid Earth, 123(2):1350-1365, 2018. ISSN 2169-9356. doi: 10.1002/2017JB014617. URL https://onlinelibrary.wiley.com/doi/abs/10.1002/2017JB014617._eprint: https://onlinelibrary.wiley.com/doi/pdf/10.1002/2017JB014617.
[7] Geoffrey C. P. King, Ross S. Stein, and Jian Lin. Static stress changes and the triggering of earthquakes. Bulletin of the Seismological Society of America, 84(3):935-953, June 1994. ISSN 0037-1106. doi: 10.1785/BSSA0840030935. URL https://doi.org/10.178S/BSSA0840030935.
[8] Paul A. Reasenberg and Robert W. Simpson. Response of Regional Seismicity to the Static Stress Change Produced by the Loma Prieta Earthquake. Science, 255(5052):1687-1690 March 1992. doi: 10. 1126/science.255.5052.1687. URL https://www.science.org/doi/10.1126/science.255.5052.1687. Publisher: American Association for the Advancement of Science.
[9] Lian-She Zhao and Donald V. Helmberger. Source estimation from broadband regional seismograms. Bulletin of the Seismological Society of America, 84(1):91-104, February 1994. ISSN 0037-1106. doi: 10.1785/BSSA0840010091. URL https://doi.org/10.1785/BSSA0840010091.
[10] Lupei Zhu and Donald V. Helmberger. Advancement in source estimation techniques using broadband regional seismograms. Bulletin of the Seismological Society of America, 86(5):1634-1641 October 1996. ISSN 0037-1106. doi: 10.1785/BSSA0860051634. URL https://doi.org/10.1785/BSSA0860051634.
[11] Li Zhao, Po Chen, and Thomas H. Jordan. Strain Green's Tensors, Reciprocity, and Their Applications to Seismic Source and Structure Studies. Bulletin of the Seismological Society of America, 96(5):17531763, October 2006. ISSN 0037 -1106.doi: 10.1785/0120050253. URL https://doi.org/10.1785/0120050253.
[12] Paul Reasenberg and D. H. Oppenheimer. FPFIT, FPPLOT and FPPAGE; Fortran computer programs for calculating and displaying earthquake fault-plane solutions. Technical Report 85-739, U.S. Geological Survey, 1985. URL hups://pubs.er.usgs.gov/publication/ofr85739. ISSN: 2331-1258 Publication Title: Open-File Report.
[13] Jeanne L. Hardebeck and Peter M. Shearer. A New Method for Determining First-Motion Focal Mechanisms. Bulletin of the Seismological Society of America, 92(6):2264-2276 August 2002. ISSN 0037-1106. doi: 10.1785/0120010200. URL https://doi.org/10.1785/0120010200.
[14] Debi Kilb and Jeanne L. Hardebeck. Fault Parameter Constraints Using Relocated Earthquakes: A Validation of First-Motion Focal-Mechanism Data. Bulletin of the Seismological Society of America, 96(3):1140-1158 June 2006. ISSN 0037-1106. doi: 10.1785/0120040239. URL https://doi.org/10.1785/0120040239.
[15] Takahiko Uchide, Takahiro Shiina, and Kazutoshi Imanishi. Stress Map of Japan: Detailed Nationwide Crustal Stress Field Inferred From Focal Mechanism Solutions of Numerous Microearthquakes. Journal of Geophysical Research: Solid Earth, 127(6):e2022JB024036, 2022. ISSN 2169-9356. doi: 10.1029/2022JB024036. URL https://onlinelibrary.wiley.com/doi/abs/10.1029/2002JB024036._ eprint: https://onlinelibrary.wiley.com/doi/pdf/10.1029/2022JB024036.
[16] D. J. Pugh, R. S. White, and P. A. F. Christie. A Bayesian method for microseismic source inversion.
Geophysical Journal International, 206(2):1009-1038 August 2016. ISSN 0956-540X. doi: 10.1093/gji/ggw186. URL https://doi.org/10.1093/gji/ggw186.
[17] Takahiko Uchide. Focal mechanisms of small earthquakes beneath the Japanese islands based on firstmotion polarities picked using deep learning. Geophysical Journal International, 223(3):1658-1671 November 2020. ISSN 0956-540X. doi: 10.1093/gji/ggaa401. URL https://doi.org/10.1093/gji/ggaa401.
[18] Wenhuan Kuang, Congcong Yuan, and Jie Zhang. Real-time determination of earthquake focal mechanism via deep learning. Nature Communications, 12(1):1432 March 2021. ISSN 2041-1723. doi: 10.1038/s41467-021-21670-x. URL https://www.nature.com/articles/s41467-021-21670-x. Number: 1 Publisher: Nature Publishing Group.
[19] Jeanne L. Hardebeck and Peter M. Shearer. Using S/P Amplitude Ratios to Constrain the Focal Mechanisms of Small Earthquakes. Bulletin of the Seismological Society of America, 93(6):2434-2444 December 2003. ISSN 0037-1106. doi: 10.1785/0120020236. URL https://doi.org/10.1785/0120020236.
[20] Wenzheng Yang, Egill Hauksson, and Peter M. Shearer. Computing a Large Refined Catalog of Focal Mechanisms for Southern California (1981-2010): Temporal Stability of the Style of Faulting. Bulletin of the Seismological Society of America, 102(3):1179-1194 June 2012. ISSN 0037-1106. doi: 10.1785/0120110311. URL https://doi.org/10.1785/0120110311.
[21] David R. Shelly, Jeanne L. Hardebeck, William L. Ellsworth, and David P. Hill. A new strategy for earthquake focal mechanisms using waveform-correlation-derived relative polarities and cluster analysis: Application to the 2014 Long Valley Caldera earthquake swarm. Journal of Geophysical Research: Solid Earth, 121(12):8622-8641, 2016. ISSN 2169-9356. doi: 10.1002/2016JB013437. URL https://onlinelibrary.wiley.com/doi/abs/10.1002/2016JB013437._eprint: https://onlinelibrary.wiley.com/doi/pdf/10.1002/2016JB013437.
[22] David R. Shelly, Robert J. Skoumal, and Jeanne L. Hardebeck. S/P Amplitude Ratios Derived from Single-Component Seismograms and Their Potential Use in Constraining Focal Mechanisms for Microearthquake Sequences. The Seismic Record, 2(2):118-126, May 2022. ISSN 2694-4006. doi: 10.1785/0320220002. URL https://doi.org/10.1785/0320220002.
Robert J. Skoumal, David R. Shelly, and Jeanne L. Hardebeck. Using Machine Learning Techniques with Incomplete Polarity Datasets to Improve Earthquake Focal Mechanism Determination. Seismological
Research Letters, September 2022. ISSN 0895-0695. doi: 10.1785/0220220103. URL https://doi.org/10.1785/0220220103.
[24] David R. Shelly, Robert J. Skoumal, and Jeanne L. Hardebeck. Fracture-Mesh Faulting in the SwarmLike 2020 Maacama Sequence Revealed by High-Precision Earthquake Detection, Location, and Focal Mechanisms. Geophysical Research Letters, 50(1):e2022GL101233, 2023. ISSN 1944-8007. doi: 10.1029/2022GL101233. URL https://onlinelibrary.wiley.com/doi/abs/10.1029/2022GL101233._ eprint: https://onlinelibrary.wiley.com/doi/pdf/10.1029/2022GL101233.
[25] Robert J. Skoumal, Jeanne L. Hardebeck, and David R. Shelly. Using Corrected and Imputed Polarity Measurements to Improve Focal Mechanisms in a Regional Earthquake Catalog Near the Mt. Lewis Fault Zone, California. Journal of Geophysical Research: Solid Earth, 128(2):e2022JB025660, 2023. ISSN 2169-9356. doi: 10.1029/2022JB025660. URL https://onlinelibrary.wiley.com/doi/abs/10.1029/2022JB025660._eprint: https://onlinelibrary.wiley.com/doi/pdf/10.1029/2022JB025660.
[26] Zuyuan He and Qingwen Liu. Optical Fiber Distributed Acoustic Sensors: A Review. Journal of Lightwave Technology, 39(12):3671-3686 June 2021. ISSN 1558-2213. doi: 10.1109/JLT.2021.3059771. Conference Name: Journal of Lightwave Technology.
[27] Zhongwen Zhan. Distributed Acoustic Sensing Turns Fiber-Optic Cables into Sensitive Seismic Antennas. Seismological Research Letters, 91(1):1-15, December 2019. ISSN 0895-0695. doi: 10.1785/0220190112. URL https://doi.org/10.1785/0220190112.

[28] Nathaniel J. Lindsey and Eileen R. Martin. Fiber-Optic Seismology. Annual Review of Earth and Planetary Sciences, 49(1):309-336, 2021. doi: 10.1146/annurev-earth-072420-065213. URL https://doi.org/10.1146/annurev-earth-072420-065213._eprint: https://doi.org/10.1146/annurev-earth072420-065213.
[29] Nathaniel J. Lindsey, Eileen R. Martin, Douglas S. Dreger, Barry Freifeld, Stephen Cole, Stephanie R. James, Biondo L. Biondi, and Jonathan B. Ajo-Franklin. Fiber-Optic Network Observations of Earthquake Wavefields. Geophysical Research Letters, 44(23):11,792-11,799, 2017. ISSN 1944-8007. doi: 10.1002/2017GL075722. URL https://onlinelibrary.wiley.com/abs/10.1002/2017GL075722._eprint: https://onlinelibrary.wiley.com/doi/pdf/10.1002/2017GL075722.
[30] Jonathan B. Ajo-Franklin, Shan Dou, Nathaniel J. Lindsey, Inder Monga, Chris Tracy, Michelle Robertson, Veronica Rodriguez Tribaldos, Craig Ulrich, Barry Freifeld, Thomas Daley, and Xiaoye
Li. Distributed Acoustic Sensing Using Dark Fiber for Near-Surface Characterization and Broadband Seismic Event Detection. Scientific Reports, 9(1):1328 February 2019. ISSN 2045-2322. doi: 10.1038/s41598-018-36675-8. URL https://www.nature.com/articles/s41598-018-36675-8. Number: 1 Publisher: Nature Publishing Group.
[31] Nathaniel J. Lindsey, Horst Rademacher, and Jonathan B. Ajo-Franklin. On the Broadband Instrument Response of Fiber-Optic DAS Arrays. Journal of Geophysical Research: Solid Earth, 125(2):e2019JB018145, 2020. ISSN 2169-9356. doi: 10.1029/2019JB018145. URL https://onlinelibrary.wiley.com/doi/abs/10.2019JB018145._eprint: https://onlinelibrary.wiley.com/doi/pdf/10.1029JB018145.
[32] T. S. Hudson, A. F. Baird, J. M. Kendall, S. K. Kufner, A. M. Brisbourne, A. M. Smith, A. Butcher, A. Chalari, and A. Clarke. Distributed Acoustic Sensing (DAS) for Natural Microseismicity Studies: A Case Study From Antarctica. Journal of Geophysical Research: Solid Earth, 126(7):e2020JB021493, 2021. ISSN 2169-9356. doi: 10.1029/2020JB021493. URL https.//onlinelibrary.wiley.com/doi/abs/10. 1029/2020JB021493._eprint: https://onlinelibrary.wiley.com/doi/pdf/10.1029/2020JB021493.
[33] Philippe Jousset, Gilda Currenti, Benjamin Schwarz, Athena Chalari, Frederik Tilmann, Thomas Reinsch, Luciano Zuccarello, Eugenio Privitera, and Charlotte M. Krawczyk. Fibre optic distributed acoustic sensing of volcanic events. Nature Communications, 13(1):1753 March 2022. ISSN 2041-1723. doi: 10.1038/s41467-022-29184-w. URL https://www.nature.com/articles/s4167-022-29184-w. Number: 1 Publisher: Nature Publishing Group.
[34] Andreas Fichtner, Sara Klaasen, Solvi Thrastarson, Yeşim Çubuk-Sabuncu, Patrick Paitz, and Kristin Jonsdottir. Fiber-Optic Observation of Volcanic Tremor through Floating Ice Sheet Resonance. The Seismic Record, 2(3):148-155, July 2022. ISSN 2694-4006. doi: 10.1785/0320220010. URL https://doi.org/10.1785/0320220010.
[35] Jiuxun Yin, Weiqiang Zhu, Jiaxuan Li, Ettore Biondi, Yaolin Miao, Zack J. Spica, Loïc Viens, Masanao Shinohara, Satoshi Ide, Kimihiro Mochizuki, Allen L. Husker, and Zhongwen Zhan. Earthquake Magnitude With DAS: A Transferable DataBased - Scaling Relation. Geophysical Research Letters, 50(10):e2023GL103045, 2023. ISSN 1944-8007. doi: 10.1029/2023GL103045. URL https://onlinelibrary.wiley.com/doi/abs/10.1029/2023GL103045._eprint: https://onlinelibrary.wiley.com/pdf/10.1029/2023GL103045.
[36] Steve Cole, Martin Karrenbach, Dan Kahn, Jamie Rich, Ken Silver, and David Langton. Source parameter estimation from DAS microseismic data. In SEG Technical Program Expanded Abstracts 2018, SEG
Technical Program Expanded Abstracts, pages 4928-4932. Society of Exploration Geophysicists, August 2018. doi: 10.1190/segam2018-2995716.1. URL https://library.seg.org/doi/10.1190/segam20182995716.1.
[37] Martin Karrenbach and Steve Cole. DAS microseismic source mechanism estimation by forwardmodeling. In SEG Technical Program Expanded Abstracts 2019, SEG Technical Program Expanded Abstracts, pages 1004-1008. Society of Exploration Geophysicists, August 2019. doi: 10.1190/segam20193216570.1. URL https://library.seg.org/doi/10.1190/segam2019-3216570.1.
[38] A. F. Baird, A. L. Stork, S. A. Horne, G. Naldrett, J.-M. Kendall, J. Wookey, J. P. Verdon, and A. Clarke. Characteristics of microseismic data recorded by distributed acoustic sensing systems in anisotropic media. Geophysics, 85(4):KS139-KS147, June 2020. ISSN 0016-8033. doi: 10.1190/geo2019-0776.1. URL https://doi.org/10.1190/geo2019-0776.1.
[39] Ismael Vera Rodriguez and Andreas Wuestefeld. Strain microseismics: Radiation patterns, synthetics, and moment tensor resolvability with distributed acoustic sensing in isotropic media. GEOPHYSICS, 85(3):KS101-KS114, May 2020. ISSN 0016-8033. doi: 10.1190/geo2019-0373.1. URL https://library.seg.org/doi/full/10.1190/geo2019-0373.1. Publisher: Society of Exploration Geophysicists.
[40] T. S. Hudson, A. M. Brisbourne, F. Walter, D. Graff, R. S. White, and A. M. Smith. Icequake Source Mechanisms for Studying Glacial Sliding. Journal of Geophysical Research: Earth Surface, 125(11):e2020JF005627, 2020. ISSN 2169-9011. doi: 10.1029/2020JF005627. URL https://onlinelibrary.wiley.com/doi/abs/10.1029/2020JF005627._eprint: https://onlinelibrary.wiley.com/doi/pdf/10.1029/2020JF005627.
[41] Xin Wang and Zhongwen Zhan. Moving from 1-D to 3-D velocity model: automated waveform-based earthquake moment tensor inversion in the Los Angeles region. Geophysical Journal International, 220(1):218-234, January 2020. ISSN 0956-540X. doi: 10.1093/gji/ggz435. URL https://doi.org/10.1093/gji/ggz435.
[42] Weiqiang Zhu, Ettore Biondi, Jiaxuan Li, Jiuxun Yin, Zachary E. Ross, and Zhongwen Zhan. Seismic Arrival-time Picking on Distributed Acoustic Sensing Data using Semi-supervised Learning, March 2023. URL http://arxiv.org/abs/2302.08747. arXiv:2302.08747 [physics].
[43] J. C. VanDecar and R. S. Crosson. Determination of teleseismic relative phase arrival times using multi-channel cross-correlation and least squares. Bulletin of the Seismological Society of America, 80
(1):150-169, February 1990. ISSN 0037-1106. doi: 10.1785/BSSA0800010150. URL https://doi.org/10.1785/BSSA0800010150.
[44] NCEDC. Northern California Earthquake Data Center. UC Berkeley Seismological Laboratory. Dataset., 2014. URL doi: 10.7932/NCEDC.
[45] SCEDC. Southern California Earthquake Center. Caltech.Dataset., 2013. URL doi: 10.7909/C3WD3xH1.
[46] U.S. Geological Survey and California Geological Survey. Quaternary fault and fold database for the United States. URL https://www.usgs.gov/natural-hazards/earthquake-hazards/faults.
[47] NASA JPL. NASA Shuttle Radar Topography Mission Global 1 arc second, 2013. URL https://1pdaac.usgs.gov/products/srtmgl1v003/.
[48] https://www.science.org/doi/10.1126/science.aay5881
[49] Further information on one or more embodiments of the present invention can be found in Earthquake focal mechanisms with distributed acoustic sensing by Jiaxuan Li et. al Nature Communications volume 14, Article number: 4181 (2023).
[50] Aki and Richards-2002-p. 108-110 discussing forward problem in seismology.

### Conclusion

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method, comprising:
inferring a polarity of body waves sensed across each of a plurality of distributed acoustic sensing (DAS) channels by cross-correlating pairs of DAS data sets representing the body waves received from one or more pairs of seismic events; and
performing a focal mechanism inversion using the polarity obtained using the DAS data sets.

2. The method of claim 1, wherein the body waves are P-waves and the polarity is a first-motion polarity of the P-waves.

3. The method of claim 1, further comprising:
the cross-correlating between all the pairs of the DAS data sets, both at the same one of the channels and adjacent ones of the channels, to obtain same channel correlation data and adjacent channel correlation data;
picking relative polarities of the correlation data;
deriving channel consistent polarities of the correlation data; and
performing the focal mechanism inversion using the channel consistent polarities and non-DAS polarity picks as inputs, to obtain a focal mechanism.

4. The method of claim 1, further comprising:
obtaining the distributed acoustic sensing (DAS) data sets, comprising changes in strain in an optical fiber as a function of time, wherein each of the sets are generated in response to a different one of a plurality of seismic events and the optical fiber is embedded in a geological structure;
performing the cross-correlating of one or more pairs of the sets associated with the P-waves sensed in a same one of the channels of the optical fiber, to obtain same channel correlation data;
performing the cross-correlating of the one or more pairs of the sets associated with the P-waves sensed at two different adjacent ones of the channels, to obtain adjacent channel correlation data;
using the adjacent channel correlation data to correct a sign ambiguity in the same channel correlation data, to obtain corrected correlation data;
using the corrected correlation data to determine relative signs of the first motion polarities of the P-waves from all the seismic events; and
determining the first motion polarities of the P-waves from all the seismic events, from a knowledge of at least one of the first motion polarities and the relative signs.

5. The method of claim 4, wherein the knowledge is obtained from a measurement of the polarity using a an inertial sensor or other conventional sensor.

6. The method of claim 4, further comprising:
using single value decomposition to invert a matrix equation representing the cross correlation data (without the sign ambiguity) to obtain the relative signs;
assigning the first motion polarities from the relative signs using the knowledge of at least one of the polarities.

7. The method of claim 1, wherein the arrivals of the P-waves and the correlations between the DAS data sets, comprising positive and negative correlations.

8. The method of claim 1, wherein:
a length of each of the channels, comprising computationally defined channels, is less than a wavelength of the body wave;
a spatial separation (spacing) between the two adjacent ones of the channels is less than the wavelength or a portion of the wavelength.

9. The method of claim 1, further comprising applying a filter to set a time window of the DAS data sets to less than 2 seconds or the time window having a length tailored to capture one or more periods of the body wave of interest while excluding any waves corresponding to seismic phases different from the body wave of interest.

10. The method of claim 1, further comprising inferring, from the inversion, at least one of a fault orientation or a stress status associated with seismic events.

11. The method of claim 1, further comprising monitoring earthquakes using the focal mechanism inversion.

12. The method of claim 11, wherein the earthquake is generated in one or more fault zones onshore or offshore, a geothermic reservoir, or carbon storage and sequestration location.

13. A computer-implemented system, comprising:
(a) one or more computers having one or more memories;
(b) one or more processors executing on the one or more computers;
(c) the one or more memories storing one or more sets of instructions, wherein the one or more sets of instructions, when executed by the one or more processors cause the one or more processors to perform operations comprising:
calculating a polarity of body waves sensed across each of a plurality of distributed acoustic sensing (DAS) channels by cross-correlating pairs of DAS data sets representing the body waves received from one or more pairs of seismic events; and
performing a focal mechanism inversion using the polarity obtained using the DAS data sets.

14. The system of claim 13, wherein the body waves comprise P-waves and the polarities comprises first motion polarities.

15. The system of claim 13, wherein the one or more processors perform the operations further comprising:
obtaining the distributed acoustic sensing (DAS) data sets, comprising changes in strain in an optical fiber as a function of time, wherein each of the sets are generated in response to a different one of a plurality of seismic events and the optical fiber is embedded in a geological structure;
performing the cross-correlating of one or more pairs of the sets associated with the P-waves sensed in a same one of the channels of the optical fiber, to obtain same channel correlation data;
performing the cross-correlating of the one or more pairs of the sets associated with the P-waves sensed at two different adjacent ones of the channels, to obtain adjacent channel correlation data;
using the adjacent channel correlation data to correct a sign ambiguity in the same channel correlation data, to obtain corrected correlation data;
using the corrected correlation data to determine relative signs of the first motion polarities from all the seismic events; and
determining the first motion polarities of the P-waves from all the seismic events, from a knowledge of at least one of the first motion polarities and the relative signs.

16. The system of claim 13, further comprising
the optical fiber and an interrogator coupled to the optical fiber, wherein the interrogator comprises a laser source for outputting laser pulses into the fiber and a detector for detecting backscattering of the laser pulses from the optical fiber in response to deformations of the geological structure in contact with the optical fiber and caused by the seismic events.

17. The system of claim 16, wherein one or more of the processors define the channels comprising a length corresponding to at least one of a time range, frequency range, or phase range of the backscattering of the laser pulses detected by the detector.

18. The system of claim 13, further comprising a system of holes or wells drilled in the geological structure for extracting energy from the geological structure using a fluid pumped into and/or extracted from the geological structure through the holes or wells, and one or more of the computers comprising one or more processors using the focal mechanism inversion as an input for simulating fluid flow in the holes or wells so as to monitor and/or predict energy production from the system of the holes or wells.

19. A computer-readable storage medium storing instructions that, when executed by a computing system, cause the computing system to perform a process comprising:
inferring a polarity of body waves sensed across each of a plurality of distributed acoustic sensing (DAS) channels by cross-correlating pairs of DAS data sets representing the body waves received from one or more pairs of seismic events; and
performing a focal mechanism inversion using the polarity obtained using the DAS data sets.

20. The medium of claim 19, wherein the process further comprises:
obtaining the distributed acoustic sensing (DAS) data sets, comprising changes in strain in an optical fiber as a function of time, wherein each of the sets are generated in response to a different one of a plurality of seismic events and the optical fiber is embedded in a geological structure;
performing the cross-correlating of one or more pairs of the sets associated with the P-waves sensed in a same one of the channels of the optical fiber, to obtain same channel correlation data;
performing the cross-correlating of the one or more pairs of the sets associated with the P-waves sensed at two different adjacent ones of the channels, to obtain adjacent channel correlation data;
using the adjacent channel correlation data to correct a sign ambiguity in the same channel correlation data, to obtain corrected correlation data;
using the corrected correlation data to determine relative signs of the first motion polarities from all the seismic events; and
determining the first motion polarities of the P-waves from all the seismic events, from a knowledge of at least one of the first motion polarities and the relative signs.
